(19) United States
(12) Patent Application Publication
(10) Pub. No.: US 2026/0093403 A1
(43) Pub. Date: Apr. 2, 2026

(54) MULTI-COUNTER MEMORY ENCRYPTION SYSTEMS AND TECHNIQUES FOR TARGETED ACCESS OF INDIVIDUAL MEMORY BLOCKS

(71) Applicant: Cryptography Research, Inc., San Jose, CA (US)

(72) Inventors: Marco Aurelio Lisboa Silveira, Eindhoven (NL); Cezar Rodolfo Wedig Reinbrecht, Berkel-Enschot (NL); Ajay Kapoor, Eindhoven (NL)

(21) Appl. No.: 19/333,068

(22) Filed: Sep. 18, 2025

Related U.S. Application Data
(60) Provisional application No. 63/700,415, filed on Sep. 27, 2024.

(51) Int. Cl. G06F 3/06

(52) U.S. Cl. CPC G06F 3/0622; G06F 3/064; G06F 3/0679

(57) ABSTRACT

Disclosed aspects and implementations are directed to systems and techniques for multi-counter memory encryption with targeted access of individual memory blocks. In one example, replacing a stored block in a memory device includes encrypting a replacement block using a first initialization vector (IV) having a block counter associated with a number of times the stored block has been previously replaced, replacing the stored block with the encrypted replacement block in the memory device, encrypting a second IV to obtain a tag encryption vector, the second IV including a tag counter associated with a number of times an authentication tag for a plurality of blocks has been previously updated, and updating, using the encrypted second IV, the authentication tag for the plurality of blocks.

### CLAIM OF PRIORITY

The present application claims the benefit under 35 U.S.C. § 119(e) of U.S. Provisional Patent Application No. 63/700,415, entitled “MULTI-COUNTER MEMORY ENCRYPTION SYSTEMS AND TECHNIQUES FOR TARGETED ACCESS OF INDIVIDUAL MEMORY BLOCKS,” filed Sep. 27, 2024, which is incorporated in its entirety by reference herein.

### TECHNICAL FIELD

The disclosure pertains to cryptographic computing applications and, more specifically, to cryptographic engines and techniques that allow efficient access and replacement of individual encrypted memory blocks data in computer applications.

### BRIEF DESCRIPTION OF THE DRAWINGS

The present disclosure will be understood more fully from the detailed description given below and from the accompanying drawings of various implementations of the disclosure.

FIG. 1 is a block diagram illustrating an example system architecture in which implementations of the present disclosure may operate.

FIGS. 2A-2B are block diagrams illustrating operations of a multi-counter memory encryption system with targeted access of individual memory blocks, in accordance with one or more implementations of the present disclosure.

FIG. 3 illustrates an example architecture of a cryptographic engine capable of multi-counter memory encryption with targeted access of individual memory blocks, in accordance with one or more aspects of the present disclosure.

FIG. 4 depicts a flow diagram of an example method of targeted replacement of encrypted memory blocks using multiple counters, in accordance with one or more aspects of the present disclosure.

FIG. 5 depicts a block diagram of an example computer system operating in accordance with one or more aspects of the present disclosure.

### DETAILED DESCRIPTION

In many modern computing applications, data is stored in a computing memory in an encrypted form (inline memory encryption). For example, various ciphers may perform block-wise encryption of stored data. For example, a block may have a 128-bit size. Additionally, a cryptographic engine encrypting the data may authenticate the data to detect instances of a malicious program or attacker tampered with the data. Such tampering can include spoofing, where an attacker removes a portion of data and/or replaces the data with some other data, a replay attack, where data of some blocks is replaced with an older version of the data at those blocks, or a splicing attack, where data stored at particular blocks is replaced with data stored at different blocks. To protect against such attacks, an authentication tag (also known as a message authentication code or MAC) may be computed for encrypted blocks of a sector (e.g., a 4-block sector, an 8-block sector, etc.). During decryption, a control tag can be computed using the decrypted blocks and compared with the stored authentication tag. A mismatch of the tags signals possible tampering with the data.

In one example of AES-GSM systems, storage of data includes an authentication tag being generated using an initialization vector IV₀ that includes a nonce value and a starting (e.g., 1) value of a counter. The initialization vector IV₀ is encrypted using a suitable cipher to generate a tag encryption vector Y for the initial tag. Furthermore, individual blocks of plaintext data, e.g., PT₁, . . . PT₄, are encrypted by processing, through the cipher, respective initialization vectors IV₁, . . . IV₄ that include the same nonce value and a sequentially incremented counter and combining (e.g., adding) the outputs to the respective plaintext blocks to obtain respective ciphertext blocks, PTⱼ→CTⱼ. The obtained ciphertext blocks CTⱼ are then stored in a memory device. In addition, the authentication tag is generated by computing a polynomial Σⱼ CTⱼ·H^{N-j} with a hash key H and a suitable exponent N (e.g., N=6 when four blocks are being encrypted). The authentication tag is then “closed” by adding the tag encryption vector Y to this polynomial. (The closure may also include some additional inputs, such as the length of the data being stored, a memory address where the data is stored and so on). When one of blocks of the sector needs to be overwritten with a new data, all blocks of the sector have to be read, decrypted, and the new data being stored in the block and the old data previously stored in the rest of the sector have to be re-encrypted using a new initialization vector (which may include a new nonce and the counter starting back at the initial value, e.g., 1). A new authentication tag is then generated to authenticate the data using the new initialization vector. Such a full sector read and the tag update result in a significant overhead of memory operations.

Aspects and implementations of the present disclosure address these and other challenges of the encrypted memory operations by providing for systems and techniques that implement efficient encryption of data during partial memory accesses and do not require a full sector read/re-authentication when only one or several blocks of a group of blocks are replaced. In some implementations, the techniques include maintaining multiple counters and using different initialization vectors. For example, a Data IV may be used for encryption of blocks and a separate Tag IV may be used for generating authentication tags. In one example, Data IV may have the following fields:

$$Data IV = Nonce ‖ Selector ‖ Block\_Counter ‖ Global\_Counter ,$$

including a Nonce field (e.g., a random number) and a Selector field indicating whether the initialization vector is a Data IV or Tag IV. For example, Selector may be a one-bit field having value 0 (or 1) for Data IV or value 1 (or 0) for Tag IV. The Data IV may further include a Block_Counter field indicating how many times a given block has been replaced and a Global_Counter field indicating an index or some other identifier of the block. Similarly, Tag IV may have the following fields:

$$Tag IV = Nonce ‖ Selector ‖ Tag\_Counter ,$$

with a Tag_Counter field indicating how many times a new tag has been generated and used in encryption of authentication tags of the sector.

More specifically, initial storage of the blocks of the sector may be performed using initial Data IV=Nonce∥0∥0∥1 and Tag IV=Nonce∥1∥1. Subsequently, when one (or more) blocks of the sector are to be overwritten, Data IV is updated by incrementing a current value of Block_Counter. The updated Data IV may then be used to generate a new ciphertext block CTⱼ, which is stored in memory. The tag may then be updated by subtracting the old value and adding a new value of the monomial CTⱼ·H^{N-j} to the tag. (In implementations where modulo-2 XOR addition is used, subtraction of a value is equivalent to addition of the same value.) Similarly, the old tag encryption vector Y_{OLD} may be subtracted and a new tag encryption vector Y_{NEW} computed using the updated Tag IV may be added.

The disclosed techniques eliminate the need to read, decrypt, and re-encrypt data blocks that are not replaced thus significantly reducing the processing overhead of inline memory encryption as the authentication tag is updated using a minimal number of operations performed using a new and old block's ciphertext values. Further advantages of the disclosed techniques enable the use of larger sectors since overwriting individual blocks no longer comes with the high overhead of decryption/encryption of all other blocks of the sector.

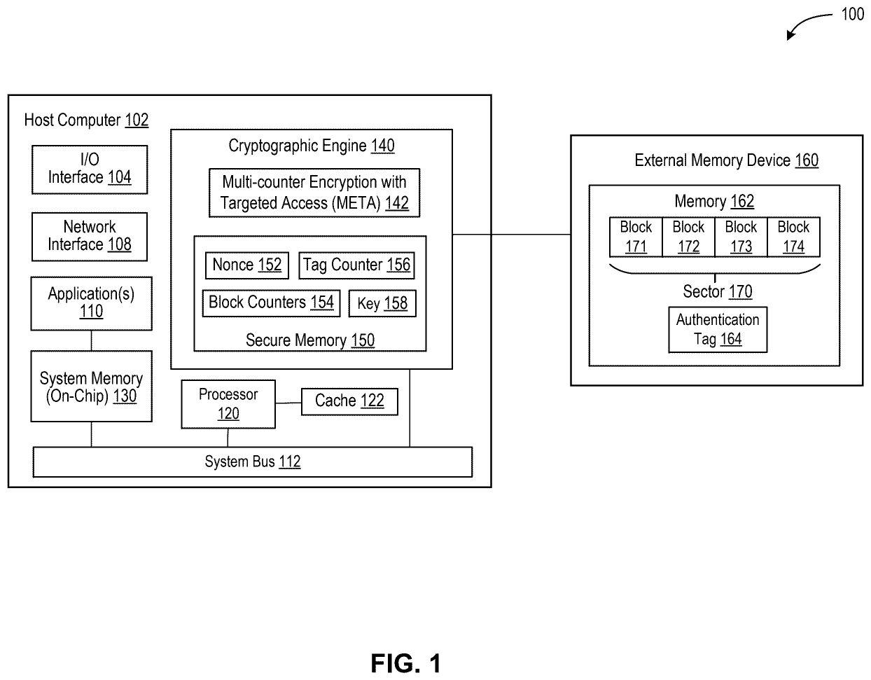

FIG. 1 is a block diagram illustrating an example system architecture 100 in which implementations of the present disclosure may operate. The example system architecture 100 may include a desktop computer, a tablet, a smartphone, a server (local or remote), a thin/lean client, and the like. The example system architecture 100 may include a host computer 102, which may be any computing device, a server, a cloud computing node, a card reader, a wireless sensor node, an Internet-of-Things (IoT) node, an embedded system dedicated to one or more specific applications, and so on. One or more applications 110 may be executed on host computer 102. The system architecture 100 may include, but need not be limited to, a host computer 102 having one or more processors 120, e.g., CPUs, GPUs, field-programmable gate arrays (FPGA), application-specific integration circuits (ASICs), and the like. “Processor” herein refers to a device capable of executing instructions encoding arithmetic, logical, or I/O operations. In one illustrative example, a processor may follow von Neumann architectural model and may include one or more arithmetic logic units (ALUs), a control unit, and may further have access to a plurality of registers, such as a cache 122.

Host computer 102 may have access to one or more system memory 130 devices. The system memory 130 may refer to any volatile or non-volatile memory and may include a read-only memory (ROM), a random-access memory (RAM), as well as (not shown) electrically erasable programmable read-only memory (EEPROM), flash memory, flip-flop memory, or any other device capable of storing data. RAM may be a dynamic random-access memory (DRAM), synchronous DRAM (SDRAM), a static memory, such as static random-access memory (SRAM), and the like. In some implementations, system memory 130 may be an on-chip memory. In some implementations, processor(s) 120 and the system memory 130 may be implemented as a single controller, e.g., as a FPGA.

The system architecture 100 may further include an input/output (I/O) interface 104 to facilitate connections of the host computer 102 to various peripheral hardware devices (not shown) such as card readers, terminals, printers, scanners, IoT devices, and the like. The system architecture 100 may further include a network interface 108 to facilitate connection to a variety of networks (Internet, wireless local area networks (WLAN), personal area networks (PAN), public networks, private networks, etc.), and may include a radio front end module and other devices (amplifiers, digital-to-analog and analog-to-digital converters, dedicated logic units, etc.) to implement data transfer to/from host computer 102. Various hardware components of the host computer 102 may be connected via a system bus 112 that may include its own logic circuits, e.g., a bus interface logic unit (not shown).

Application(s) 110 supported by host computer 102 may include machine-learning application(s), graphics application(s), computational application(s), cryptographic application(s) (such as authentication, encryption, decryption, secure storage application(s), etc.), video applications, audio applications, video/audio conferencing applications, embedded application(s), external application(s), or any other types of application(s) that may be executed by host computer 102. Application(s) 110 may be instantiated on the same host computer 102, e.g., by an operating system executed by the processor 120 and residing in system memory 130. Alternatively, the external application(s) 110 may be instantiated by a guest operating system supported by a virtual machine monitor (hypervisor) operating on the host computer 102. In some implementations, the external application(s) may reside on a remote access client device or a remote server (not shown), with the host computer 102 providing cryptographic support for the client device and/or the remote server.

The processor 120 may include one or more processor cores having access to a single or multi-level cache and one or more hardware registers. In implementations, each processor core may execute instructions to run a number of hardware threads, also known as logical processors. Various logical processors (or processor cores) may be assigned to one or more application(s) 110, although more than one processor core (or a logical processor) may be assigned to a single application for parallel processing. A multi-core processor 120 may simultaneously execute multiple instructions. A single-core processor 120 may typically execute one instruction at a time (or process a single pipeline of instructions). The processor 120 may be implemented as a single integrated circuit, two or more integrated circuits, or may be a component of a multi-chip module.

Host computer 102 may include a cryptographic engine 140 to implement encryption, decryption, and authentication of data, e.g., any data stored in system memory 130, communicated over a suitable network (not shown in FIG. 1) via network interface 104, and/or any suitable interconnect. In some implementations, cryptographic engine 140 and system memory 130 (e.g., a DRAM) may be implemented on a monolithic chip. Cryptographic engine 140 may perform authentication of applications, users, access requests, in association with operations of application(s) 110 or any other applications operating on or in conjunction with the host computer 102. Cryptographic engine 140 may include processing and memory components that are different from processor 120 and system memory 130. For example, cryptographic engine 140 may include, or have access to, a high-speed cache (not shown in FIG. 1) and/or secure memory 150. Secure memory 150 may have hardware and/or software protections against adversarial attacks, e.g., secure memory 150 may have low and/or random emissions of electromagnetic and/or thermal signals making it difficult for an adversarial attacker to use malicious hardware and/or software to track and access data being stored and/or retrieved from secure memory 150.

Cryptographic engine 140 may be configured to perform digital signature operations, key encapsulation operations, and/or any other applicable cryptographic operations. In some implementations, cryptographic engine 140 may be a separate hardware component, e.g., an accelerator. In some implementations, cryptographic engine 140 may be implemented as a software (or firmware) module instantiated in secure memory device. In some implementations, cryptographic engine 140 may be partially implemented as a hardware component and partially as a software (or firmware) module. Cryptographic engine 140 may include an encryption engine to encrypt plaintext messages and generate ciphertexts and a decryption engine to decrypt ciphertexts and recover plaintext messages.

In some implementations, cryptographic engine 140 may include multi-counter encryption with targeted access (META) 142, which is to be understood to perform both the encryption and the decryption of data. During encryption operations, META 142 may receive data from processor 120 or system memory 130 (e.g., via system bus 112), process the received data, identify a destination device for the processed/received data, select a specific key to be used with the destination device, generate a ciphertext using the selected key and provide the generated ciphertext to a destination device, e.g., system memory 130 or any suitable external device, such as external memory device 160. Operations of META 142 may be supported by various data stored in secure memory 150, including but not limited to nonce(s) 152 to store session-specific (e.g., random) values used to generate initialization vectors, block counters 154 to track a number of times a particular block of destination memory (e.g., system memory 130 and/or external memory device 160) has been overwritten, tag counter 156 that tracks the number of times a new authentication tag has been replaced, one or more cryptographic keys 158, and/or any other secret data.

External memory device 160 may provide any suitable functionalities to host computer 102. For example, external memory device 160 may include memory 162 for storing and reading data by processor 120 of host computer 102. Memory 162 may be subdivided into multiple sectors 170 (one example sector is illustrated in FIG. 1). An individual sector 170 may be protected by an authentication tag 164 and include any number of blocks. Four blocks 171-174 are illustrated as part of sector 170, but any other number, e.g., two, eight, ten, sixteen, etc., of blocks may be combined into a sector. As disclosed herein, individual blocks 17x of sector 170 may store encrypted (ciphertext) data that can be accessed and replaced individually.

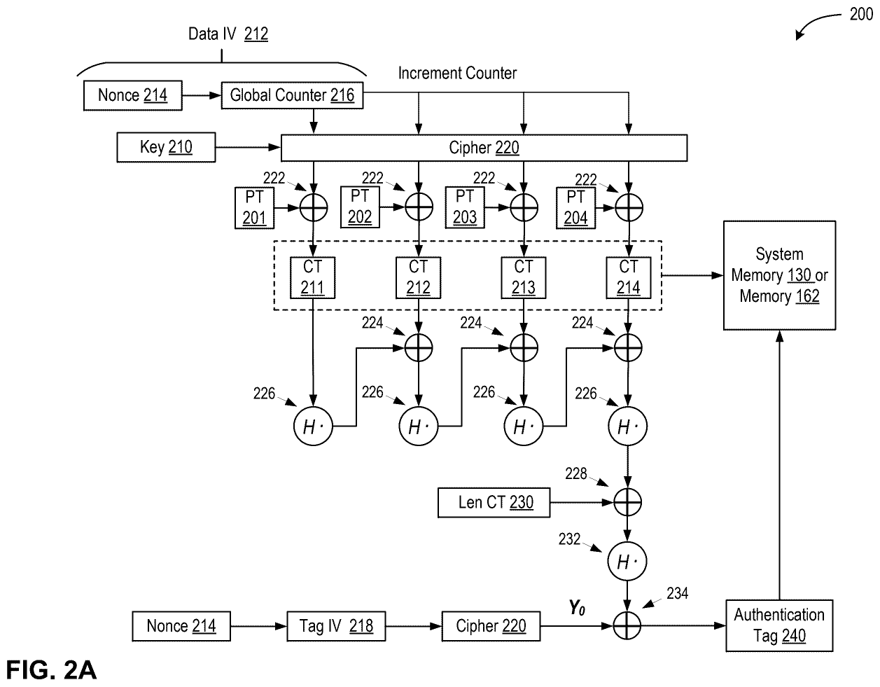

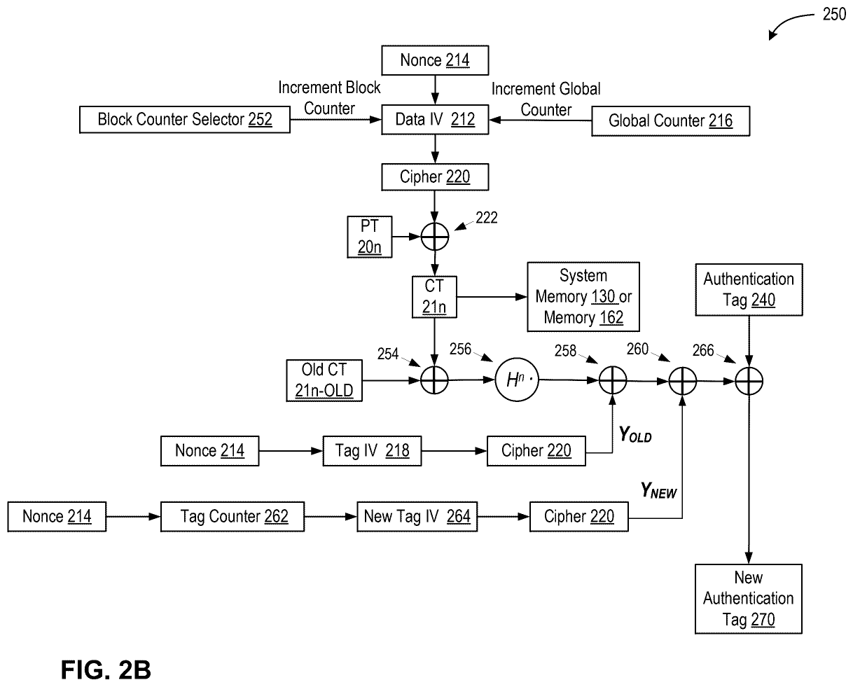

FIGS. 2A-2B are block diagrams illustrating operations of a multi-counter memory encryption system with targeted access of individual memory blocks, in accordance with one or more implementations of the present disclosure. In some implementations, operations illustrated with FIGS. 2A-2B may be performed by cryptographic engine 140 (with reference to FIG. 1), e.g., responsive to instructions of META 142. FIG. 2A illustrates operations 200 associated with an initial encryption and storage of data in multiple blocks of a particular memory sector. For the sake of simplicity and ease of viewing, a memory sector illustrated in FIG. 2A has four blocks, e.g., 16-byte blocks or blocks of any other suitable size.

As depicted in FIG. 2A, operations 200 may encrypt a parcel of data that includes multiple plaintext blocks (PT) 201 . . . 204. Plaintext blocks 20n may have any suitable size, e.g., 16 bytes, 32 bytes, 64 bytes, etc. Plaintext blocks 20n may be encrypted using any suitable cipher 220, e.g., AES cipher, SM4 cipher, and the like, and produce corresponding ciphertext (CT) blocks 21n, e.g., CT 211-214. The encryption process may be based on a key 210, which may be any suitable cryptographic key, including but not limited to a symmetric key. An additional input into cipher 220 may include a Data IV 212 which may be formed by concatenating a nonce 214 (e.g., a 96-bit number) with a global counter 216, e.g., which is a block index inside the sector. Value 1 of global counter 216 may be used to generate a Tag IV 218, e.g., Tag IV=Nonce∥1∥1, where the selector bit value 1 in the second field indicates that the initialization vector is to be used as a tag IV. Cipher 220 may process Tag IV 218 to generate an initial tag encryption vector Y₀. Sequential non-zero values of global counter 216 may be used to generate Data IV 212 for encryption of consecutive plaintext blocks PT 20n. For example, Data IV 212 for encryption of PT 201 may be Data IV=Nonce∥0∥0∥2, Data IV 212 for encryption of PT 202 may be Data IV=Nonce∥0∥0∥3, and so on, where the selector bit value 0 in the second field indicates that the initialization vector is to be used as a data IV, value 0 in the third field indicates the initial storage of data in the block, and the value in the fourth field indicates the block index (1, 2, and 3 in this example). The outputs of cipher 220 processing, Cipher(Nonce∥0∥0∥n) may then be added, e.g., using XOR adders 222, to the plaintext blocks 20n to obtain respective ciphertext blocks 21n. In some implementations, operations 200 may use some additional inputs, including any suitable authentication metadata associated with a sector of data being encrypted, e.g., a memory address, a data version number, a block number (identifier) in the sector, and/or the like.

In some implementations, cipher 220 encrypts each plaintext block 20n independently and in parallel. In some implementations, cipher 220 encrypts different plaintext blocks 20n sequentially. The encrypted ciphertext blocks 21n may be stored in one or more memory devices, e.g., system memory 130 of host computer 102, memory 162 of external memory device 160 (with reference to FIG. 1) and/or any other suitable memory device. For example, plaintext 201 may be stored in block 171 of memory 162, plaintext 202 may be stored in block 172, and so on.

Authentication tag 240 may be computed using a set of multiplication circuits 226 and XOR adders 224. Each multiplication circuit 226 may multiply an input into the circuit by a precomputed auxiliary value H (hash key), which may be a string of zeros, or some other suitable value, encrypted by a cipher (e.g., cipher 220) using a cryptographic key (e.g., key 210). Multiplication circuits 226 may be circuits that perform polynomial multiplications over Galois fields GF(2^{P}) with P elements. For example, if ciphertext block size is 16 bytes (128 bits), 32 bytes, etc., the multiplication may be over Galois fields GF(2¹²⁸), GF(2²⁵⁶), etc. As illustrated, multiplication circuits 226 and XOR adders 224 compute an intermediate value (CT₁·H⁴)⊕(CT₂·H³)⊕(CT₃·H²)⊕(CT₄·H). Another XOR adder 228 may then add a value Len CT 230 that represents a length of a cyphertext block (or any other suitable metadata). A final multiplication circuit 232 may perform one additional multiplication and a final XOR adder 234 may add a tag encryption vector Y₀ to obtain the (initial) authentication tag 240:

$$Tag = ( {CT}_{1} \cdot {H}^{5} ) ⊕ ( {CT}_{2} \cdot {H}^{4} ) ⊕ ( {CT}_{3} \cdot {H}^{3} ) ⊕ ( {CT}_{4} \cdot {H}^{2} ) ⊕ ( Len CT \cdot H ) ⊕ {Y}_{0} .$$

The computed authentication tag 240 may also be stored in memory.

FIG. 2B illustrates operations 250 associated with a targeted access to an individual stored block initially stored as illustrated in FIG. 2A. As depicted in FIG. 2B, when ciphertext block 21n is to be replaced, operations 250 may update Data IV 212. For example, Data IV 212 may be

$$Data IV = Nonce ‖ Selector ‖ Block\_Counter ‖ Global\_Counter ,$$

and may include nonce 214 and selector bit (e.g., 0) indicating that the IV is to be used for data (rather than tag) encryption. Furthermore, a block counter selector 252 may access (e.g., at a secure memory of the cryptographic processor) a number of times a ciphertext block 21n has been previously replaced, update this number (e.g., by incrementing this number by one), and place the updated number at the Block_Counter field. Additionally, the block index may be placed in the Global_Counter field. The updated Data IV 212 may then be processed by cipher 220 and the result added (using XOR adder 222) to the new plaintext block 20n to generate a new ciphertext block 21n, which is stored in memory.

To obtain a new authentication tag 270, data associated with the old ciphertext may be replaced in the old authentication tag 240 with data associated with the new ciphertext. More specifically, XOR adder 254 may compute the combination of the old ciphertext block 21n-OLD and the new ciphertext block 21n and a multiplication circuit 256 may multiply this combination by the corresponding power of the auxiliary value, H^{m}·(CT_{n-OLD}⊕CTₙ). XOR adder 258 may add an old tag encryption vector Y_{OLD} (which may be the initial tag encryption vector Y₀ or a tag encryption vector used in a subsequent replacement) and XOR adder 260 may add a new tag encryption vector Y_{NEW}. The new tag encryption vector Y_{NEW} may be computed using the same nonce 214 and the incremented tag counter 262 to form a new Tag IV 264, e.g., Tag IV=Nonce∥1∥Tag_Counter, which is then encrypted by cipher 220. A final XOR adder 266 adds the old authentication tag 240 to obtain new authentication tag 270.

The computations of new authentication tag 270 illustrated in FIG. 2B amount to performing the following operations:

$${Tag}_{NEW} = Tag ⊕ ( {CT}_{n - OLD} ⊕ {CT}_{n - NEW} ) \cdot {H}^{m} ⊕ {Y}_{OLD} ⊕ {Y}_{NEW} = {CT}_{1} \cdot {H}^{5} ⊕ ( {CT}_{2} \cdot {H}^{4} ) ⊕ ( {CT}_{3} \cdot {H}^{3} ) ⊕ ( {CT}_{4} \cdot {H}^{2} ) ⊕ ( Len CT \cdot H ) ⊕ {Y}_{NEW} .$$

XOR adder 254 and multiplication circuit 256 exchange of the old ciphertext block for the new ciphertext block and adders 258 and 260 exchange of the old tag authentication vector for the new tag authentication vector. The encrypted ciphertext block 21n may be stored in one or more memory devices, e.g., system memory 130 of host computer 102, memory 162 of external memory device 160 (with reference to FIG. 1) and/or any other suitable memory device.

Although operations 250 illustrate, for brevity and conciseness, replacement of a single stored block, the same or substantially the same operations may be performed to replace multiple blocks of a sector (group) of blocks. In such instances, separate Data IV 212 may be generated for different replaced blocks, each having a block counter specific to that particular block, and global counter 216 may be incremented sequentially for different blocks. Cipher 220 may then generate (e.g., in parallel or sequentially) new ciphertext blocks 21n for each block being replaced and XOR adder 254 may similarly compute a combination of the old ciphertext block 21n-OLD and the new ciphertext block 21n. Multiplication circuit 256 may then multiply each such computed combination by an appropriate power of the hash value (the power being different for different blocks). The computation of Y_{OLD} (or retrieval of Y_{OLD} from a secure memory) and Y_{NEW} may be performed substantially as disclosed above (once for all blocks).

A size of block counters may be made based on an expected rate of accesses to individual blocks. In one non-limiting example, a 128-bit Data IV 212 may include a 96-bit nonce, a 1-bit selector bit, a 4-bit block counter, and a 27-bit global counter. For security of memory encryption, security protocols may prescribe that the same initialization vector is not to be used twice. Correspondingly, a new nonce may be generated every time any of the block counters reaches a maximum value, with the first encryption/authenticated of the sector performed according to operations 200 of FIG. 2A and subsequent replacements performed according to operations 250 of FIG. 2B. In the above example, a new nonce is generated when any of the blocks is to be replaced for the sixteenth (2⁴) time.

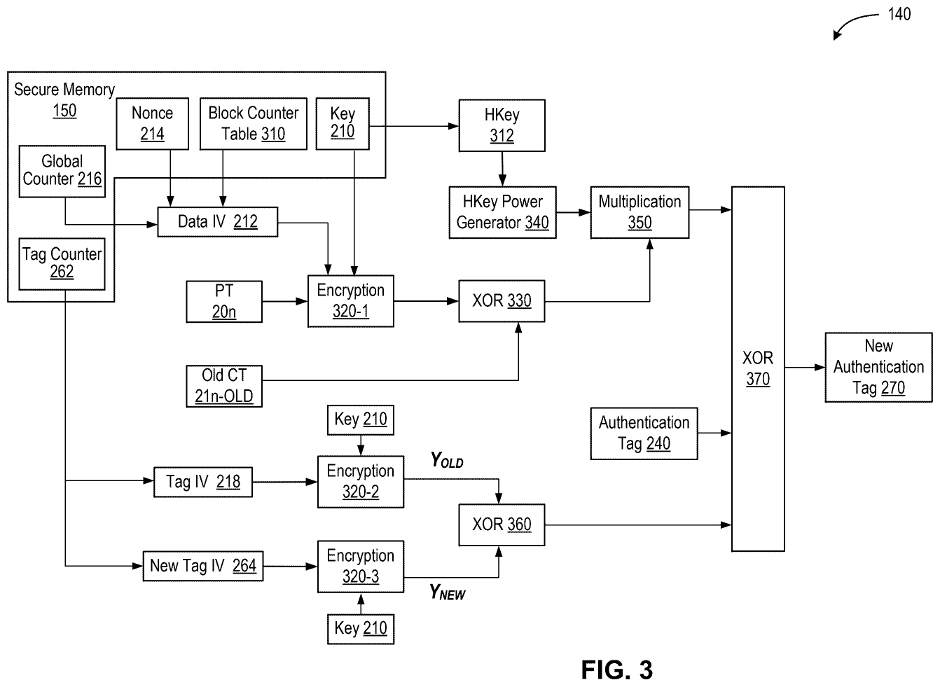

FIG. 3 illustrates an example architecture of a cryptographic engine capable of multi-counter memory encryption with targeted access of individual memory blocks, in accordance with one or more aspects of the present disclosure. In some implementations, the cryptographic engine illustrated in FIG. 3 may be cryptographic engine 140 (with reference to FIG. 1). Cryptographic engine 140 may include secure memory 150 that stores one or more cryptographic keys 210 (which may include ephemeral keys, session keys, symmetric keys, and/or any other suitable keys), a nonce 214 (which may be a randomly or pseudorandomly generated value), and one or more counters. For example, secure memory 150 may store a block counter table 310 that tracks the number of times individual blocks of data have been replaced (overwritten). Secure memory 150 may also store tag counter 262 that tracks the number of times a new authentication tag has been generated (for the same nonce 214).

Cryptographic engine 140 may include one or more encryption circuits 320-n to perform encryption of data, which may be performed using cryptographic key 210. In some implementations, encryption circuits 320-n may implement functionality of ciphers 220 in FIGS. 2A-2B. Although three encryption circuits 320-1, 320-2, and 320-3 are illustrated in FIG. 3 (e.g., capable of performing encryption and/or decryption of data in parallel), in some implementations, a single encryption circuit may be used (e.g., performing various instances of encryption and/or decryption sequentially).

As illustrated in FIG. 3, encryption circuit 320-1 may receive and encrypt a new plaintext block 20n. XOR circuit 330 may then compute the combination CT_{n-NEW}⊕CT_{n-OLD} of the new encrypted block and the old ciphertext block 21n. A hash key (HKey) circuit 312 may compute a hash H of cryptographic key 210. An HKey power generator 340 may generate a power of the hash H^{m} with the power (exponent) m that depends on a location of a particular block being replaced within its sector of memory blocks. For example, in the instances of a sector having four blocks, replacing the first block may involve generating H⁵, replacing the second block may involve generating H⁴, replacing the third block may involve generating H³, replacing the fourth block may involve generating H², and so on. In some implementations, HKey power generator 340 may compute the corresponding power of the HKey live (on the fly). In some implementations, HKey power generator 340 may precompute various powers of HKey, store the precomputed powers in secure memory 150, and retrieve appropriate powers of HKey when a particular block is being replaced.

A multiplication circuit 350 may then compute the product (CT_{n-NEW}⊕CT=_{n-OLD}) H^{m}. In some implementations, multiplication circuit 350 may be (or include) a modular multiplication circuit. In some implementations, multiplication circuit 350 may perform multiplication over suitable Galois fields GF(2^{p}).

As further illustrated in FIG. 3, encryption circuit 320-2 may encrypt old Tag IV 218 formed using nonce 214 and the prior tag counter 262 to generate old tag encryption vector Y_{OLD}. Similarly, encryption circuit 320-3 may encrypt the new Tag IV 264 formed using nonce 214 and the updated (e.g., incremented by 1) tag counter 262 to generate new tag encryption vector Y_{NEW}. XOR circuit 360 may compute the combination of the two tag encryption vectors, Y_{OLD}⊕Y_{NEW}.

XOR circuit 370 may combine the output of multiplication circuit 350, e.g., (CT_{n-NEW} ⊕CT_{n-OLD})·H^{m}, with the output of XOR circuit 360, e.g., Y_{OLD}⊕Y_{NEW}, and the (old) authentication tag 240 to generate the new authentication tag 270. Although three XOR circuits 330, 360, and 370 are illustrated in FIG. 3, in some implementations, a single encryption circuit may perform all XOR additions sequentially. In some implementations, cryptographic engine 140 may include two XOR circuits, e.g., 330 and 360, operating in parallel, with the functions of XOR circuit 370 performed by XOR circuit 330 or XOR circuit 360.

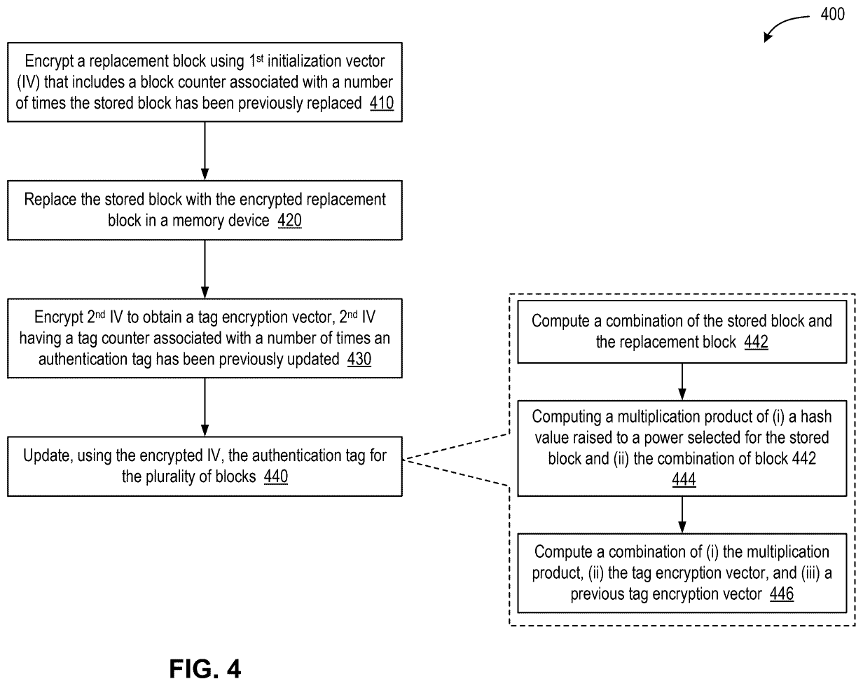

FIG. 4 depicts a flow diagram of an example method 400 of targeted replacement of encrypted memory blocks using multiple counters, in accordance with one or more aspects of the present disclosure. Method 400 disclosed below, and/or each of its individual functions, routines, subroutines, or operations may be performed by one or more processing units of a suitable computing system, e.g., cryptographic engine 140 or processor 120 of host computer 102 illustrated in FIG. 1. In some implementations, method 400 may be performed by an arithmetic logic unit, an FPGA, an ASIC, a cryptographic accelerator, a dedicated hardware circuit, or any other suitable processing logic, implemented in hardware, firmware, and/or software or as a combination thereof. In certain implementations, method 400 may be performed by a single processing thread. Alternatively, method 400 may be performed by two or more processing threads, each thread executing one or more individual functions, routines, subroutines, or operations of the method. In an illustrative example, the processing threads implementing method 400 may be synchronized (e.g., using semaphores, critical sections, and/or other thread synchronization mechanisms). Alternatively, the processing threads implementing method 400 may be executed asynchronously with respect to each other. Various operations of method 400 may be performed in a different order compared with the order shown in FIG. 4. Some of the operations method 400 may be performed concurrently with other operations. Some operations of method 400 may not always be performed.

Method 400 may be performed to replace a stored block (e.g., CT 21n-OLD in FIG. 3) in a memory device (e.g., system memory 130 or external memory device 160 in FIG. 1). In some implementations, method 400 may include, at block 410, encrypting a replacement block (e.g., PT 20n in FIG. 3) using a first initialization vector (e.g., Data IV 212 in FIG. 2B and FIG. 3). The first initialization vector may include a block counter. The block counter may be associated with a first number of times the stored block has been previously replaced or overwritten. In some implementations, the block counter may be selected from a stored plurality of counters (e.g., block counter table 310 in FIG. 3). An individual block counter of the stored plurality of counters may be associated with a number of times a corresponding block of the plurality of blocks has been previously replaced. In some implementations, encrypting the replacement block is performed using one or more cipher circuits (e.g., cipher 220 in FIG. 2B or encryption circuit 320-1 in FIG. 3). The one or more cipher circuits may implement AES encryption, SM4 encryption, and/or other suitable encryption protocols.

At block 420, method 400 may continue with replacing the stored block with the encrypted replacement block in the memory device.

At block 430, method 400 may include encrypting a second initialization vector (e.g., a new Tag IV 264 in FIG. 2B and FIG. 3) to obtain a tag encryption vector (e.g., Y_{NEW}). In some implementations, the second initialization vector may include a tag counter (e.g., tag counter 262 in FIG. 2B). The tag counter may be associated with a second number of times an authentication tag for a plurality of blocks has been previously updated. The plurality of blocks (e.g., a sector of N blocks) may include the stored block. In some implementations, encrypting the second initialization vector may be performed using the same cipher circuit(s) that encrypt the replacement block. In some implementations, each of the first initialization vector and the second initialization vector may include a same nonce value (e.g., nonce 214 in FIG. 2B and FIG. 3).

In some implementations, method 400 may continue, at block 440, with updating, using the encrypted second initialization vector, the authentication tag for the plurality of blocks (e.g., update authentication tag 240 to obtain a new authentication tag 270, with reference to FIG. 2B and FIG. 3). In some implementations, updating the authentication tag may include one or more operations illustrated with the callout portion of FIG. 4. More specifically, at block 442, method 400 may include computing, using an XOR operation (e.g., implemented by XOR circuit 330 in FIG. 3), a combination (e.g., CT_{n-NEW}⊕CT_{n-OLD}) of the stored block (e.g., CT_{n_OLD}) and the encrypted replacement block (e.g., CT_{n-NEW}). At block 444, method 400 may continue with computing a multiplication product (e.g., (CT_{n-NEW}⊕CT_{n-OLD})·H^{m}) of (i) a hash value (e.g., H^{m}) raised to a power selected based on an identifier of the stored block in the plurality of blocks and (ii) the combination of the stored block and the replacement block. The identifier of the stored block may be associated with an assigned order of the stored block in the plurality of blocks. In some implementations, the hash value may be obtained using a cryptographic key, e.g., by encrypting a null vector using the cryptographic key and a suitable hash function. At block 446, method 400 may include computing, using the XOR operation, a combination of (i) the multiplication product, (ii) the tag encryption vector, and (iii) a previous tag encryption vector (e.g., Y_{OLD}), which may be computed in association with a previous replacement of one or more blocks of the plurality of blocks (e.g., as illustrated with a sequence of blocks 214, 218, and 220 in FIG. 2B).

In some implementations, operations of method 400 may be performed responsive to determining that the first number of times (e.g., the number of times the stored block has been previously replaced or overwritten) does not exceed a maximum value, e.g., a maximum number that may be stored in a block counter.

In some implementations, operations of method 400 may be used to replace multiple blocks of the plurality of blocks, e.g., two, three, etc. In such instances, one or more additional blocks of the plurality of blocks may be encrypted using a respective additional initialization vector of a plurality of additional initialization vectors. The respective additional initialization vector may include a block counter associated with a number of times a respective additional block has been previously replaced. Furthermore, updating the authentication tag may include using the tag encryption vector, the encrypted replacement block and the one or more encrypted additional blocks. For example, multiplication products (CT_{n-NEW}⊕CT_{n-OLD})·H^{m} may be computed for each block that is being replaced and used to update the second initialization vector. In such instances, a single tag encryption vector may still be used to update the second initialization vector.

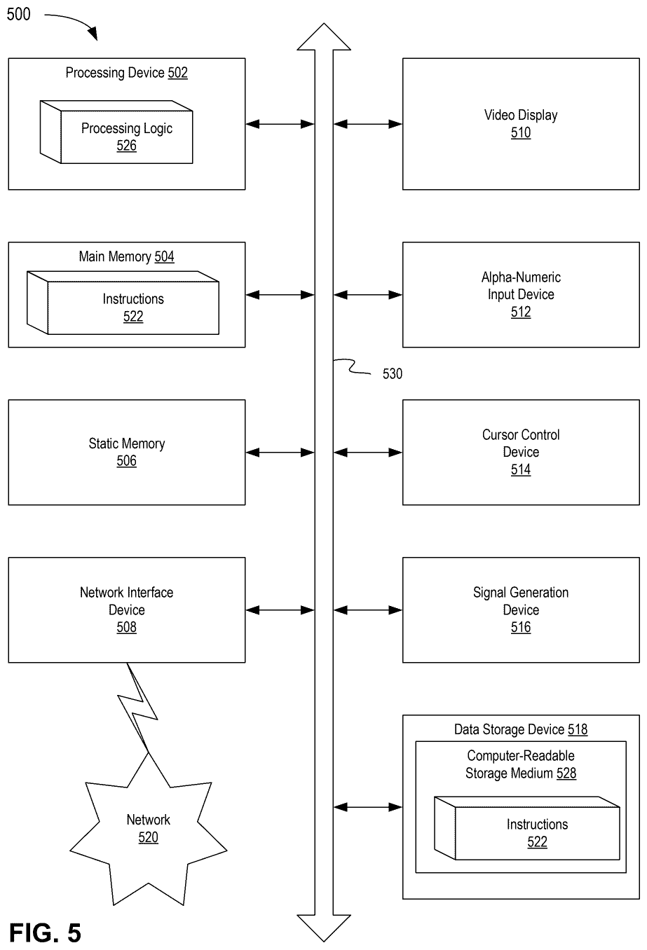

FIG. 5 depicts a block diagram of an example computer system 500 operating in accordance with one or more aspects of the present disclosure. In various illustrative examples, computer system 500 may include host computing device 102, illustrated in FIG. 1. Example computer system 500 may be connected to other computer systems in a LAN, an intranet, an extranet, and/or the Internet. Computer system 500 may operate in the capacity of a server in a client-server network environment. Computer system 500 may be a personal computer (PC), a set-top box (STB), a server, a network router, switch or bridge, or any device capable of executing a set of instructions (sequential or otherwise) that specify actions to be taken by that device. Further, while only a single example computer system is illustrated, the term “computer” shall also be taken to include any collection of computers that individually or jointly execute a set (or multiple sets) of instructions to perform any one or more of the methods discussed herein.

Example computer system 500 may include a processing device 502 (also referred to as a processor or CPU), which may include processing logic 526, a main memory 504 (e.g., read-only memory (ROM), flash memory, dynamic random access memory (DRAM) such as synchronous DRAM (SDRAM), etc.), a static memory 506 (e.g., flash memory, static random access memory (SRAM), etc.), and a secondary memory (e.g., a data storage device 518), which may communicate with each other via a bus 530.

Processing device 502 represents one or more general-purpose processing devices such as a microprocessor, central processing unit, or the like. More particularly, processing device 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. In accordance with one or more aspects of the present disclosure, processing device 502 may be configured to execute instructions implementing example method 400 of targeted replacement of encrypted memory blocks using multiple counters.

Example computer system 500 may further comprise a network interface device 508, which may be communicatively coupled to a network 520. Example computer system 500 may further comprise a video display 510 (e.g., a liquid crystal display (LCD), a touch screen, or a cathode ray tube (CRT)), an alphanumeric input device 512 (e.g., a keyboard), a cursor control device 514 (e.g., a mouse), and an acoustic signal generation device 516 (e.g., a speaker).

Data storage device 518 may include a computer-readable storage medium (or, more specifically, a non-transitory computer-readable storage medium) 528 on which is stored one or more sets of executable instructions 522. In accordance with one or more aspects of the present disclosure, executable instructions 522 may comprise executable instructions implementing example method 400 of targeted replacement of encrypted memory blocks using multiple counters.

Executable instructions 522 may also reside, completely or at least partially, within main memory 504 and/or within processing device 502 during execution thereof by example computer system 500, main memory 504 and processing device 502 also constituting computer-readable storage media. Executable instructions 522 may further be transmitted or received over a network via network interface device 508.

While the computer-readable storage medium 528 is shown in FIG. 5 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus may be specially constructed for the required purposes, or it may be a general purpose computer system selectively programmed by a computer program stored in the computer system. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages may be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A method to replace a stored block in a memory device, the method comprising:
encrypting, by a processing device, a replacement block using a first initialization vector (IV), wherein the first IV comprises a block counter associated with a first number of times the stored block has been previously replaced;
replacing the stored block with the encrypted replacement block in the memory device;
encrypting, by the processing device, a second IV to obtain a tag encryption vector, wherein the second IV comprises a tag counter associated with a second number of times an authentication tag for a plurality of blocks has been previously updated, wherein the plurality of blocks comprises the stored block; and
updating, by the processing device and using the encrypted second IV, the authentication tag for the plurality of blocks.

2. The method of claim 1, further comprising:
determining that the first number of times does not exceed a maximum value.

3. The method of claim 1, wherein each of the first IV and the second IV comprise a same nonce value.

4. The method of claim 1, wherein the block counter is selected from a stored plurality of counters, an individual block counter of the stored plurality of counters associated with a number of times a corresponding block of the plurality of blocks has been previously replaced.

5. The method of claim 1, wherein updating the authentication tag comprises:
computing, using an XOR operation, a combination of the stored block and the encrypted replacement block.

6. The method of claim 5, wherein updating the authentication tag further comprises:
computing a multiplication product of (i) a hash value raised to a power selected based on an identifier of the stored block in the plurality of blocks and (ii) the combination of the stored block and the replacement block, wherein the hash value is obtained using a cryptographic key.

7. The method of claim 6, wherein updating the authentication tag further comprises:
computing, using the XOR operation, a combination of (i) the multiplication product, (ii) the tag encryption vector, and (iii) a previous tag encryption vector computed in association with a previous replacement of one or more blocks of the plurality of blocks.

8. The method of claim 1, wherein encrypting the replacement block and the second IV is performed using one or more cipher circuits, wherein the one or more cipher circuits implement at least one of AES encryption or SM4 encryption.

9. The method of claim 1, further comprising:
replacing one or more additional blocks of the plurality of blocks, wherein each of the one or more additional blocks are encrypted using a respective additional IV of a plurality of additional IV, wherein the respective additional IV comprises a respective block counter associated with a number of times a respective additional block has been previously replaced, and wherein updating the authentication tag comprises using the tag encryption vector, the encrypted replacement block and the one or more encrypted additional blocks.

10. A cryptographic processor comprising:
one or more encryption circuits to:
encrypt, using a first initialization vector (IV), a replacement block for a stored block in a memory device, wherein the first IV comprises a block counter associated with a first number of times the stored block has been previously replaced; and
encrypt a second IV to obtain a tag encryption vector, wherein the second IV comprises a tag counter associated with a second number of times an authentication tag for a plurality of blocks has been previously updated, wherein the plurality of blocks comprises the stored block;
wherein the cryptographic processor is to:
replace the stored block with the encrypted replacement block in the memory device; and
update, using the encrypted second IV, the authentication tag for the plurality of blocks.

11. The cryptographic processor of claim 10, wherein the cryptographic processor is further to:
determine that the first number of times does not exceed a maximum value.

12. The cryptographic processor of claim 10, wherein each of the first IV and the second IV comprise a same nonce value.

13. The cryptographic processor of claim 10, wherein the block counter is selected from a stored plurality of counters, an individual block counter of the stored plurality of counters associated with a number of times a corresponding block of the plurality of blocks has been previously replaced.

14. The cryptographic processor of claim 10, further comprising:
one or more XOR circuits to:
compute a combination of the stored block and the encrypted replacement block.

15. The cryptographic processor of claim 14, further comprising:
one or more multiplication circuits to:
compute a multiplication product of (i) a hash value raised to a power selected based on an identifier of the stored block in the plurality of blocks and (ii) the combination of the stored block and the replacement block, wherein the hash value is obtained using a cryptographic key.

16. The cryptographic processor of claim 15, wherein the one or more XOR circuits are further to:
compute a combination of (i) the multiplication product, (ii) the tag encryption vector, and (iii) a previous tag encryption vector computed in association with a previous replacement of one or more blocks of the plurality of blocks.

17. The cryptographic processor of claim 10, wherein the one or more encryption circuits comprise at least one of AES encryption or SM4 encryption.

18. The cryptographic processor of claim 15, wherein the cryptographic processor is further to:
replace one or more additional blocks of the plurality of blocks, wherein the one or more encryption circuits are to:
encrypt each of the one or more additional blocks using a respective additional IV of a plurality of additional IV, wherein the respective additional IV comprises a respective block counter associated with a number of times a respective additional block has been previously replaced; and
wherein to update the authentication tag, the cryptographic processor is to:
use the tag encryption vector, the encrypted replacement block and the one or more encrypted additional blocks.

19. A system comprising:
a memory device; and
a processing device communicatively coupled to the memory device, wherein the processing device is to:
encrypt, using a first initialization vector (IV), a replacement block for a stored block in a memory device, wherein the first IV comprises a block counter associated with a first number of times the stored block has been previously replaced;
replace the stored block with the encrypted replacement block in the memory device;
encrypt a second IV to obtain a tag encryption vector, wherein the second IV comprises a tag counter associated with a second number of times an authentication tag for a plurality of blocks has been previously updated, wherein the plurality of blocks comprises the stored block; and
update, using the encrypted second IV, the authentication tag for the plurality of blocks.

20. The system of claim 19, wherein to update the authentication tag, the processing device is to:
compute, using an XOR operation, a combination of the stored block and the encrypted replacement block;
compute a multiplication product of (i) a hash value raised to a power selected based on an identifier of the stored block in the plurality of blocks and (ii) the combination of the stored block and the replacement block; and
compute, using the XOR operation, a combination of (iii) the multiplication product, (iv) the tag encryption vector, and (iv) a previous tag encryption vector computed in association with a previous replacement of one or more blocks of the plurality of blocks.
